(19) United States
(12) Patent Application Publication
(10) Pub. No.: US 2015/0253962 A1
(43) Pub. Date: Sep. 10, 2015

(54) APPARATUS AND METHOD FOR MATCHING IMAGES

(71) Applicant: Samsung Electronics Co., Ltd., Gyeonggi-do (KR)

(72) Inventor: Jae-Wan Cho, Gyeonggi-do (KR)

(21) Appl. No.: 14/292,569

(22) Filed: May 30, 2014

(30) Foreign Application Priority Data
Mar. 10, 2014 (KR) 10-2014-0027680

(51) Int. Cl. G06F 3/0484; G06F 17/30; G06F 3/0488; G06K 9/62

(52) U.S. Cl. CPC G06F 3/04842; G06K 9/6201; G06F 17/3028; G06F 3/04883

(57) ABSTRACT

A method for matching images includes displaying a first image including one or more objects on a screen; and receiving an input to select at least one of the one or more objects, searching for at least one second image that matches the selected at least one, using image information of the first image, and displaying at least one second image on the screen. An electronic device includes a screen configured to display a first image including one or more objects, a sensor configured to detect a user input to select at least one of the one or more objects, a controller configured to, search for at least one second image that matches the selected at least one, using image information of the first image, and cause the screen display at least one second image on the screen. Other embodiments are also disclosed.

### CROSS-REFERENCE TO RELATED APPLICATION AND CLAIM OF PRIORITY

The present application is related to and claims the priority under 35 U.S.C. §119(a) to Korean Application Serial No. 10-2014-0027680, which was filed in the Korean Intellectual Property Office on Mar. 10, 2014, the entire content of which is hereby incorporated by reference.

### TECHNICAL FIELD

The present disclosure relates to an apparatus and method for matching images, for example, recognizing one or more objects in an image and searching for another image having an object matching the recognized object, using meta data of the image.

### BACKGROUND

Electronic devices are capable of storing various images, such as pictures, videos, or the like, and users desire to readily obtain information associated with a desired object from images. However, to detect an object recognized from an image in a current electronic device, a user needs to check all the stored images.

Therefore, to quickly detect an object and an image having features identical to objects recognized from the image, an electronic device requires a method for promptly and readily providing an image desired by the user.

### SUMMARY

When a user desires to search for information associated with a desired object from an image, a conventional method merely detects one through one method, and fails to provide a prompt and intuitive method. For example, when the user needs to additionally search for information associated with a predetermined person included in an image, the user recognizes the predetermined person and needs to directly check the information in an electronic device. To address the above-discussed deficiencies, it is a primary object to provide an image displaying method that recognizes an object included in an image and provides a search result associated with the recognized object and image, for the user's convenience.

In accordance with another aspect of the present disclosure, there is provided a method for an electronic device to display an image, the method including: displaying, on a screen, a first image including at least one object; and displaying, on the screen, at least one second image that matches image information of the first image, in response to selection of at least one object included in the first image.

In accordance with another aspect of the present disclosure, there is provided a method for an electronic device displaying a first image including one or more objects on a screen, and receiving a user input to select at least one of the one or more objects, searching for at least one second image that matches the selected at least one, using image information of the first image; and displaying at least one second image on the screen.

In accordance with another aspect of the present disclosure, there is provided a method for an electronic device to display an image, the method including: displaying, on a screen, a first image including at least one object; determining a gesture provided to at least one object included in the first image, in one of the upward direction, the downward direction, the left direction, and the right direction; determining information that matches image information of the first image; when the information that matches the image information of the first image does not exist, requesting information corresponding to the image information of the first image from a server; receiving the information from the server; and displaying a second image including the received information on the screen.

In accordance with another aspect of the present disclosure, there is provided a method for an electronic device to display an image, the method including displaying a first image including one and more objects on a screen, displaying a boundary of a partial area containing each object on the first image, receiving a gesture for selecting an object in the first image, in one of a upward direction, a downward direction, a left direction, and a right direction, obtaining image information of the first image, when a first image matching the selected object of the first image does not exist in the electronic device, requesting a second image matching the selected object and the image information of the first image from a server, receiving the second image from the server; and displaying a second image on the screen.

In accordance with another aspect of the present disclosure, there is provided a method for an electronic device to display an image, the method including: displaying a first image including at least one object on a screen; determining a gesture provided to at least one object included in the first image, in one of the upward direction, the downward direction, the left direction, and the right direction; determining image information of the first image; and displaying the image information of the first image on the screen.

In accordance with another aspect of the present disclosure, there is provided a method for an electronic device to display an image, the method including: displaying a first image including at least one object on a screen, displaying a boundary of a partial area containing each object on the first image, detecting a gesture for selecting an object in the first image, in one of a upward direction, a downward direction, a left direction, and a right direction, obtaining image information of the first image, and displaying the image information of the first image on the screen.

In accordance with another aspect of the present disclosure, there is provided an electronic device for displaying an image, the electronic device including: a screen that displays a first image including at least one object and at least one second image that matches image information of the first image; and a controller that matches the image information of the first image and at least one second image, in response to selection of at least one object included in the first image.

In accordance with another aspect of the present disclosure, there is provided an electronic device for displaying an image, the electronic device including: a screen configured to display a first image including one or more objects, a sensor configured to detect a user input to select at least one of the one or more objects, a controller configured to, search for at least one second image that matches the selected at least one, using image information of the first image and cause the screen display at least one second image on the screen.

In accordance with another aspect of the present disclosure, there is provided an electronic device for displaying an image, the electronic device including: a screen that displays a first image including at least one object and a second image; a controller that senses a gesture provided to at least one object included in the first image, in one direction of the upward direction, the downward direction, the left direction, and the right direction, determines information matching image information of the first image, and requesting information corresponding to the image information of the first image from a server when the information matching the image information of the first image does not exist; and a communication unit that receives the information from the server, wherein the screen that displays the second image includes the received information.

In accordance with another aspect of the present disclosure, there is provided an electronic device for displaying an image, the electronic device including: a screen configured to display a first image including one or more objects, a controller configure to detect a gesture for selecting at least one object included in the first image, in one of a upward direction, a downward direction, a left direction, and a right direction, search for an image matching the selected object in the electronic device, using image information of the first image, and inquiring of an image matching the selected object, using image information of the first image to a server when the matching image does not exist in the electronic device, and a communication unit configured to receive the information of the matching image from the server, wherein the screen is configured to display the matching image.

In accordance with another aspect of the present disclosure, there is provided an electronic device for displaying an image, the electronic device including: a screen that displays a first image including at least one object and image information of the first image; and a controller that determines a gesture provided to at least one object included in the first image, in one direction of the upward direction, the downward direction, the left direction, and the right direction, and determines image information of the first image.

In accordance with another aspect of the present disclosure, there is provided an electronic device for displaying an image, the electronic device including: a screen configured to display a first image including at least one object, the first image having image information; and a controller configured to determine a gesture for selecting at least one object included in the first image, in one of a upward direction, a downward direction, a left direction, and a right direction, and obtain image information of the first image.

Also, the present disclosure may include various embodiments that may be implemented within a range of the scope of the present disclosure.

According to embodiments of the present disclosure, a user may promptly and intuitively execute a search when the user searches for additional information associated with an object included in an image, and searches for additional information of the image.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an electronic device according to various embodiments of the present disclosure;

FIG. 2 is a flowchart illustrating a process of displaying an image according to an embodiment of the present disclosure;

FIG. 3 illustrates a first image according to an embodiment of the present disclosure;

FIG. 4 illustrates the recognition of an object included in a first image according to an embodiment of the present disclosure;

FIG. 5A illustrates selection of an object included in the first image and a gesture according to a first embodiment of the present disclosure;

FIG. 5B illustrates a second image with matching object identification information for identifying an object according to the first embodiment of the present disclosure;

FIG. 5C illustrates another second image with matching object identification information for identifying an object according to the first embodiment of the present disclosure;

FIG. 6 illustrates a gesture for displaying the first image and a second image according to the first embodiment of the present disclosure;

FIG. 7A illustrates the selection of an object included in a first image and a gesture according to a second embodiment of the present disclosure;

FIG. 7B illustrates a second image with matching time information according to the second embodiment of the present disclosure;

FIG. 7C illustrates another second image with matching time information according to the second embodiment of the present disclosure;

FIG. 8 illustrates a gesture for displaying the first image in a second image according to the second embodiment of the present disclosure;

FIG. 9A illustrates selection of an object included in a first image and a gesture according to a third embodiment of the present disclosure;

FIG. 9B illustrates a second image with matching location information according to the third embodiment of the present disclosure;

FIG. 9C illustrates another second image with matching location information according to the third embodiment of the present disclosure;

FIG. 10 illustrates a gesture for relocating the first image into a second image according to the third embodiment of the present disclosure;

FIG. 11A illustrates selection of an object included in a first image and a gesture according to a fourth embodiment of the present disclosure;

FIG. 11B illustrates a second image with matching biographic information of a plurality of persons from among information associated with an object according to the fourth embodiment of the present disclosure;

FIG. 11C illustrates another second image with matching biographic information of a plurality of persons from among information associated with an object according to the fourth embodiment of the present disclosure; and

FIG. 12 illustrates a gesture for displaying the first image in the second image according to the fourth embodiment of the present disclosure.

### DETAILED DESCRIPTION

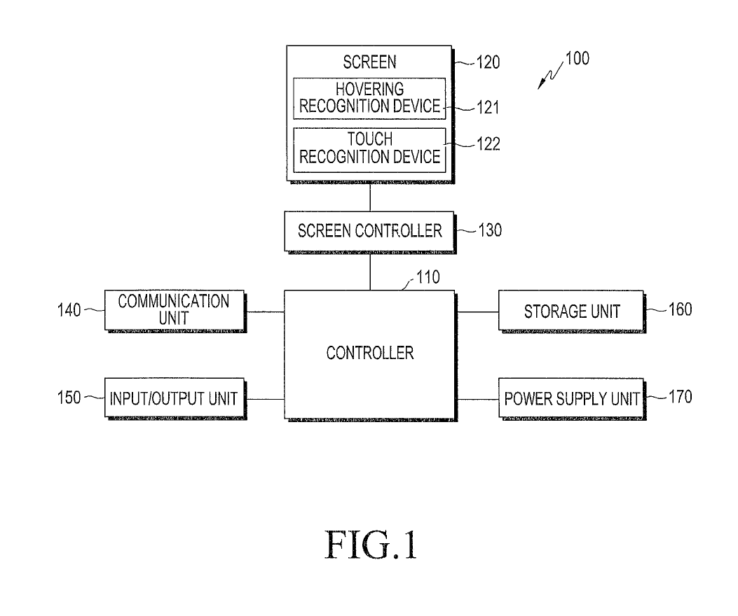

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices.

FIG. 1 illustrates an electronic device according to various embodiments of the present disclosure.

Referring to FIG. 1, an electronic device 100 can be connected to an external device (not illustrated) using at least one of a communication unit 140, a connector (not illustrated), and an earphone connection jack (not illustrated). The external device includes various devices detachably attached to the electronic device 100 by a wire, such as an earphone, an external speaker, a Universal Serial Bus (USB) memory, a charger, a cradle/dock, a Digital Multimedia Broadcasting (DMB) antenna, a mobile payment related device, a health management device (blood sugar tester or the like), a game console, a car navigation device and the like. Further, the electronic device includes a Bluetooth communication device, a Near Field Communication (NFC) device, a WiFi Direct™ communication device, and a wireless Access Point (AP) which can wirelessly access a network. The electronic device can access another device by wire or wirelessly, such as a portable terminal, a smart phone, a tablet Personal Computer (PC), a desktop PC, a digitizer, an input device, a camera and a server.

Referring to FIG. 1, the electronic device 100 includes at least one screen 120 and at least one screen controller 130. Further, the electronic device 100 can include the screen 120, the screen controller 130, the communication unit 140, an input/output unit 150, a storage unit 160, a power supply unit 170 and the controller 110.

The electronic device 100 according to the present disclosure is a mobile terminal capable of performing data transmission/reception and a voice/video call. The electronic device 100 can include one or more screens, and each of the screens can display one or more pages. The electronic device can include a smart phone, a tablet PC, 3D-TeleVision (TV), a smart TV, a Light Emitting Diode (LED) TV, a Liquid Crystal Display (LCD) TV, a tablet PC, and the like, and also can include all devices which can communicate with a peripheral device or another terminal located at a remote place. Further, at least one screen included in the electronic device can receive an input by at least one of a touch and a hovering.

The electronic device 100 can include at least one screen 120 which provides a user with user interfaces corresponding to various services, for example, calling, data transmission, broadcasting, photographing, and inputting a character string. Each screen includes a hovering recognition device 121 that recognizes an input through hovering of at least one of an input unit and a finger, and a touch recognition device 122 that recognizes an input through a touch of at least one of a finger and an input unit. The hovering recognition device 121 and the touch recognition device 122 can be referred to as a hovering recognition panel and a touch panel, respectively. Each screen can transmit an analog signal, which corresponds to at least one touch or at least one hovering input in a user interface, to a corresponding screen controller. As described above, the electronic device 100 can include a plurality of screens, and each of the screens can include a screen controller receiving an analog signal corresponding to a touch or a hovering. The screens can be connected with plural housings through hinge connections, respectively, or the plural screens can be located in one housing without the hinge connection. The electronic device 100 according to various embodiments of the present disclosure can include at least one screen as described above, and one screen will be described hereinafter for ease of the description. The input unit according to the various embodiments of the present disclosure can include at least one of a finger, an electronic pen, a digital type pen, a pen without an integrated circuit, a pen with an integrated circuit, a pen with an integrated circuit and a memory, a pen capable of performing short-range communication, a pen with an additional ultrasonic detector, a pen with an optical sensor, a joystick and a stylus pen, which can provide a command or an input to the electronic device in a state of contacting a digitizer, or in a noncontact state such as a hovering.

Further, the controller 110 can include a Central Processing Unit (CPU), a Read Only Memory (ROM) storing a control program for controlling the electronic device 100, and a Random Access Memory (RAM) used as a storage area for storing a signal or data input from the outside of the electronic device 100 or for work performed in the electronic device 100. The CPU can include a single core type CPU, or a multi-core type CPU such as a dual core type CPU, a triple core type CPU, and a quad core type CPU.

The controller 110 can control at least one of the screen 120, the hovering recognition device 121, the touch recognition device 122, the screen controller 130, the communication unit 140, the input/output unit 150, the storage unit 170, and the power supply unit 170.

The controller 110 can determine whether hovering is recognized as various input units approach any object and identify the object corresponding to a location where the hovering has occurred, in a state where various objects or an input character string is displayed on the screen 120. Further, the controller 110 can detect a height from the electronic device 100 to the input unit, and a hovering input event according to the height, in which the hovering input event can include at least one of a press of a button formed in the input unit, a tap on the input unit, a movement of the input unit at a speed higher than a predetermined speed, and a touch on an object.

The controller 110 can sense at least one gesture using at least one of a touch and a hovering input to the screen 120. The gesture includes at least one of a swipe that moves a predetermined distance while maintaining a touch on the screen 120, a flick that quickly moves while maintaining a touch on the screen 120 and removes the touch from the screen 120, a swipe through hovering over the screen 120, and a flick through hovering over the screen 120. Also, the controller 110 can determine a direction of a gesture input into the screen 120. The controller 110 can sense at least one gesture from among a swipe that moves a predetermined distance while maintaining a touch on the screen 120, a flick that quickly moves while maintaining a touch on the screen 120 and removes the touch from the screen 120, a swipe through hovering over the screen 120, and a flick through hovering over the screen 120, so as to determine a direction of the gesture. The controller 110 can determine a direction of a gesture provided through flicking or swiping on the screen 120, by determining a point on the screen 120 that is touched first and a point where the gesture ends.

The controller 110 according to an embodiment of the present disclosure can match image information of a first image and at least one second image, in response to selection of at least one object included in the first image.

The controller 110 can perform a control to display at least one image on the screen 120. The image can include at least one object, and the image can include various data such as a picture, a video, and the like. Also, the controller 110 can perform a control so as to store, in the storage unit, image information including at least one of information associated with a time of photographing an image and information associated with a location where the image is photographed. Also, the image information of an image can be determined or modified by an input of a user, and can include at least one of object identification information for identifying an object, time information associated with an image, and location information associated with an image. The image information of an image can include information that is helpful in reminding a user of a memory associated with an object that is photographed or received.

The controller 110 can match image information and at least one second image. For example, the controller 110 can control an object included in a second image to be included in the first image, so as to match the image information and at least one second image. For example, when an object included in a photographed image is a predetermined person, whether the person is identical to a person stored in advance is determined through driving a facial recognition module. When a facial recognition result shows that the person who was photographed and stored in advance is identical to the currently photographed person, the controller 110 reads object identification information (for example, a person's name or the like) included in the previously photographed object, and automatically maps the read result to the currently photographed picture for storage. Also, the controller 110 can classify a plurality of objects stored in the storage unit 160 based on the features or items, and can display a classified result on the screen 120.

As another example, the controller 110 can determine at least one second image including time information included within a predetermined time range, so as to match image information of the first image and at least one second image. The predetermined time range can be set by a user, for example, 24 hours, or an electronic device can automatically set a time range. For example, when the time range set by the user is 24 hours, the controller 110 can regard that pictures photographed during within 24 hours from a predetermined time have identical time information.

As another example, the controller 110 can determine at least one second image including location information included within a predetermined location range, so as to match image information of the first image and at least one second image. The predetermined location range can be set by the user, for example, a location within 100-meter radius, or an electronic device can automatically set a location range. For example, when the location range set by the user is 100 m, the controller 110 can classify images photographed in a location within a 100-meter radius from a location of photographing an image, as images having identical location information.

Also, when the controller 110 senses that an area that does not include object identification information is selected from the first image, the controller 110 can perform a control to display, on a screen, a popup window for receiving the object identification information. Accordingly, the controller 110 can perform a control to receive an input of the object identification information and to store the inputted information. As another example, the controller 110 can perform a control to display, in the first image on a screen, a popup window that is capable of inputting location information and time information of an image, and to store the input information.

Also, the controller 110 can control, for example, the screen 120 to display a thumbnail corresponding to image information, and to divide the thumbnail corresponding to the image information and the first image for display. Another example, the controller 110 can control the screen 120 to display one of thumbnails corresponding to image information.

Also, in a state in which a second image is displayed, when a gesture is input in a direction opposite to a gesture input for selecting at least one object, the controller 110 can perform a control to display the first image on the screen. Another example, in a state in which a second image is displayed, when a gesture input in a predetermined direction is sensed, the controller 110 performs a control to display the first image.

The controller 110 according to an embodiment of the present disclosure can sense a gesture provided to at least one object included in the first image, in one of the upward direction, the downward direction, the left direction, and the right direction. When information that matches the image information of the first image does not exist, the controller 110 can request the information corresponding to the image information of the first image from a server. As an example, the information corresponding to the image information is information associated with an object included in the first image, can include a name of the object, a place, and the like, and can include location information, weather information or the like associated with a place where the object exists.

The controller 110 according to an embodiment of the present disclosure can perform a control to sense a gesture provided to at least one object included in the first image, in one of the upward direction, the downward direction, the left direction, and the right direction, to determine information that matches the image information of the first image, and to display the image information on the screen. For example, the image information includes at least one of object identification information, time information associated with a time when the first image is stored, and location information associated with the first image.

The controller 110 according to an embodiment of the present disclosure can perform a control search for at least one second image that matches the selected at least one, using image information of the first image; and cause display at least one second image on the screen.

The controller 110 according to an embodiment of the present disclosure can perform detect a gesture for selecting at least one object included in the first image, in one of a upward direction, a downward direction, a left direction, and a right direction, search for an image matching the selected object in the electronic device, using image information of the first image, and inquiring of an image matching the selected object, using image information of the first image to a server when the matching image does not exist in the electronic device; and a communication unit configured to receive the information of the matching image from the server, wherein the screen is configured to display the matching image.

Also, the screen 120 can receive at least one touch through a body part of the user, for example, fingers including a thumb, or a touchable input unit, for example, a stylus pen or an electronic pen. Further, the screen 120 can include the hovering recognition unit 121 and the touch recognition unit 122 which can recognize an input based on a corresponding input mode, when an input is provided through a pen such as a stylus pen or an electronic pen. The hovering recognition unit 121 recognizes a distance between a pen and the screen 120 through a magnetic field, an ultrasonic wave, optical information or a surface acoustic wave, and the touch recognition unit 122 detects a position at which a touch is input through an electric charge moved by the touch. The touch recognition unit 122 can detect all touches capable of generating static electricity, and also can detect a touch of a finger or a pen which is an input unit. Also, the screen 120 can receive an input of at least one gesture through at least one of at least one touch and a hovering. The gesture includes at least one of a touch, a tap, a double tap, a flick, a drag, a drag and drop, a swipe, multi swipes, pinches, a touch and hold, a shake and a rotating. The touch is a gesture that slightly lays an input unit on the screen 120. The tap is a gesture that shortly and slightly taps an input unit on the screen 120. The double tap is a gesture that quickly taps on the screen 120 twice. The flick is a gesture that puts an input unit down on the screen 120, moves quickly the input unit, and removes the input unit (for example, a scroll). The drag is a gesture that moves or scrolls an object displayed on the screen 120. The drag and drop is a gesture that moves an object while touching the screen 120 with an input unit and removes the input unit while stopping the movement. The swipe is a gesture that moves an input unit in a predetermined distance while touching the screen 120 with the input unit. The multi-swipe is a gesture that moves at least two input units (or fingers) in a predetermined distance while touching the screen 120 with the at least two input units. The pinches correspond to a gesture that moves at least two input units (or fingers) in different directions from each other while touching the screen 120 with the at least two input units. The touch and hold is a gesture that inputs a touch or a hovering to the screen 120 until an object such as a word bubble giving advice is displayed. The shake is a gesture that shakes an electronic device to execute an operation. The rotating is a gesture that switches a direction of the screen 120 from the vertical direction to the horizontal direction and vice versa. Further, the gesture of the present disclosure can include the swipe through hovering over the screen 120 and the flick through hovering over the screen 120, in addition to the swipe that moves the input unit in a predetermined distance while maintaining a touch on the screen 120 and the flick quickly moves an input unit while maintaining a touch on the screen 120. The present disclosure can be performed using at least one gesture, which includes a gesture by at least one of various touches and the hovering which the electronic device recognizes as well as the above mentioned gesture.

Furthermore, the screen 120 can transmit an analog signal corresponding to at least one gesture to the screen controller 130.

Further, the touch in various embodiments of the present disclosure is not limited to a contact between the screen 120 and a body part of the user or a touchable input unit, and can include a non-contact (for example, an interval that can be detected without a contact between the screen 120 and a body part of a user or a touchable input unit). The distance which can be detected by the screen 120 can be changed according to a capability or a structure of the electronic device 100, and especially the touch screen 120 is configured to distinctively output values, for example, analog values including a voltage value and an electric current value, detected through a touch event and a hovering event in order to distinguish the touch event by a contact with a body part of the user or a touchable input unit, and the non-contact touch input, for example, a hovering event. Further, the screen 120 outputs different detected values, for example, a current value or the like, based on a distance between the screen 120 and a space where the hovering event is generated.

The hovering recognition unit 121 or the touch recognition unit 122 can be implemented, for example by a resistive type, a capacitive type, an infrared type, or an acoustic wave type of touch screen.

Further, the screen 120 can include at least two touch screen panels which can detect touches or approaches of a body part of the user and the touchable input unit respectively in order to sequentially or simultaneously receive inputs by the body part of the user and the touchable input unit. The at least two touch screen panels provide different output values to the screen controller, and the screen controller can recognize the values input into the at least two touch screen panels to be different values so as to distinguish whether the input from the screen 120 is an input by a body part of the user or an input by the touchable input unit. The screen 120 can display at least one object or input character string.

Particularly, the screen 120 has a structure including a touch panel which detects an input by a finger or an input unit through a change of induced electromotive force and a panel which detects a touch of a finger or an input unit on the screen 120, which are layered on each other closely or spaced from each other. The screen 120 has a plurality of pixels, and can display, through the pixels, an image or notes input by the input unit or a finger. The screen 120 can use a Liquid Crystal Display (LCD), an Organic Light Emitting Diode (OLED), or a Light Emitting Diode (LED).

Further, the screen 120 can have a plurality of sensors for identifying a position of the finger or the input unit when the finger or the input unit touches or is spaced at a distance from a surface of the screen 120. The plural sensors are individually formed to have a coil structure, and a sensor layer including the plural sensors is formed so that each sensor has a predetermined pattern and a plurality of electrode lines is formed. The touch recognition unit 122 constructed as described above can detect a signal of which a waveform is deformed due to electrostatic capacity between the sensor layer and the input unit when the finger or the input unit touches the screen 120, and the screen 120 can transmit the detected signal to the controller 110. Also, a distance between the input unit and the hovering recognition unit 121 can be determined through intensity of a magnetic field created by the coil. For example, the sensor can detect a user input to select at least one of objects.

The touch screen controller 130 converts analog signals received through a character string that is input to the screen 120, into digital signals, for example, X and Y coordinates, and then transmits the digital signals to the controller 110. The controller 110 can control the screen 120 using the digital signal received from the screen controller 130. For example, the controller 110 can allow a short-cut icon (not illustrated) or an object displayed on the screen 120 to be selected or executed in response to a touch event or a hovering event. Further, the screen controller 130 can be included in the controller 110.

The touch screen controller 130 detects a value, for example, an electric current value and the like, output through the touch screen 120 and identifies a distance between the touch screen 120 and the space in which the hovering event is generated. Then, the touch screen controller 130 converts a value of the identified distance into a digital signal, for example, a Z coordinate, and provides the controller 110 with the digital signal.

The communication unit 140 can include a mobile communication unit (not illustrated), a sub-communication unit (not illustrated), a wireless LAN (not illustrated), and a short-range communication unit (not illustrated), based on a communication scheme, a transmitting distance, and a type of transmitted and received data. The mobile communication unit enables the electronic device 100 to be connected with an external device through mobile communication using one or more antennas (not illustrated) under a control of the controller 110. The mobile communication unit can transmit/receive a wireless signal for voice communication, video communication, a Short Message Service (SMS), or a Multimedia Message Service (MMS) to/from a portable phone (not illustrated), a smart phone (not illustrated), a tablet PC, or another device (not illustrated), which has a phone number input to the electronic device 100. The sub-communication unit includes at least one of the wireless LAN unit (not illustrated) and the short-range communication unit (not illustrated). For example, the sub-communication unit can include only the wireless LAN unit, or only the short-range communication unit, or both wireless LAN unit and the short-range communication unit. Further, the sub-communication unit can transmit and receive a control signal to/from the input unit. Further, the input unit transmits a feedback signal for the control signal received from the electronic device 100 to the electronic device 100. The wireless LAN unit can access the Internet in a place where a wireless Access Point (AP) (not illustrated) is installed, under a control of the controller 110. The wireless LAN unit supports the wireless LAN provision (IEEE802.11x) of the Institute of Electrical and Electronics Engineers (IEEE). The short-range communication unit can wirelessly perform short-range communication between the electronic device 100 and an image forming apparatus (not illustrated) under a control of the controller 110. A short-range communication scheme can include a Bluetooth communication scheme, an Infrared Data Association (IrDA) communication scheme, a WiFi-Direct communication scheme, a Near Field Communication (NFC) scheme and the like.

The controller 110 can communicate with a near or remote communication device through at least one of the sub-communication unit and the wireless LAN unit, can control to receive various data including an image, an emoticon, a photograph, and the like through an Internet network, and can communicate with the input unit. The communication can be achieved by a transmission and reception of the control signal.

The electronic device 100 can include at least one of the mobile communication unit, the wireless LAN unit, and the short-range communication unit based on the performance. The electronic device 100 can include a combination of the mobile communication unit, the wireless LAN unit, and the short-range communication unit based on the performance. In the various embodiments of the present disclosure, at least one of the mobile communication unit, the wireless LAN unit, the screen and the short-range communication unit, or a combination thereof is referred to as a transmission unit, and it does not limit the scope of the present disclosure.

The input/output unit 150 can include at least one of a button (not illustrated), a microphone (not illustrated), a speaker (not illustrated), a vibration motor (not illustrated), a connector (not illustrated), and a keypad (not illustrated). Each component element included in the input/output unit 150 can be displayed on the screen 120 for executing an input/output function or being controlled. Also, the input/output unit 150 can include at least one of an earphone connecting jack (not illustrated) and an input unit (not illustrated). The input/output unit 150 is not limited thereto, and a cursor control such as a mouse, a trackball, a joystick, or cursor direction keys can be provided to control a movement of the cursor on the screen 120. The keypad (not illustrated) in the input/output unit 150 can receive a key input from a user for controlling the electronic device 100. The keypad can include a physical keypad (not illustrated) formed in the electronic device 100, or a virtual keypad (not illustrated) displayed on the screen 120. The physical keypad (not illustrated) formed in the electronic device 100 can be excluded according to the performance or a structure of the electronic device 100.

Also, the storage unit 160 can store signals, objects, or data input/output in association with operations of the communication unit 140, the input/output unit 150, the screen 120, and the power supply unit 170, based on a control of the controller 110. The storage unit can store identification information for identifying the object or data. The storage unit 160 can store a control program and applications for controlling the electronic device 100 or the controller 110. Also, the storage unit 160 can include a plurality of objects, and the objects include various data such as pictures, maps, videos, music files, emoticons, or the like. The storage unit 160 can include a nonvolatile memory, a volatile memory, a Hard Disk Drive (HDD), or a Solid State Drive (SSD). The storage unit 160 is a machine (for example, a computer)-readable medium. The term “the machine-readable medium” can be defined as a medium capable of providing data to the machine so that the machine performs a specific function. The machine-readable medium can be a storage medium. The storage unit 160 can include a non-volatile medium and a volatile medium. All of these media should be tangible so that commands transferred by the media are detected by a physical instrument through which the machine reads the commands.

The power supply unit 170 can supply electric power to one or more batteries (not illustrated) disposed in the housing of the electronic device 100 under a control of the controller 110. The one or more batteries (not illustrated) supply electrical power to the electronic device 100. Further, the power supply unit 170 can supply, to the electronic device 100, electrical power input from an external power source (not illustrated) through a wired cable connected to a connector (not illustrated). Furthermore, the power supply unit 170 can supply electric power, which is wirelessly input from the external electric power source through a wireless charging technology, to the electronic device 100.

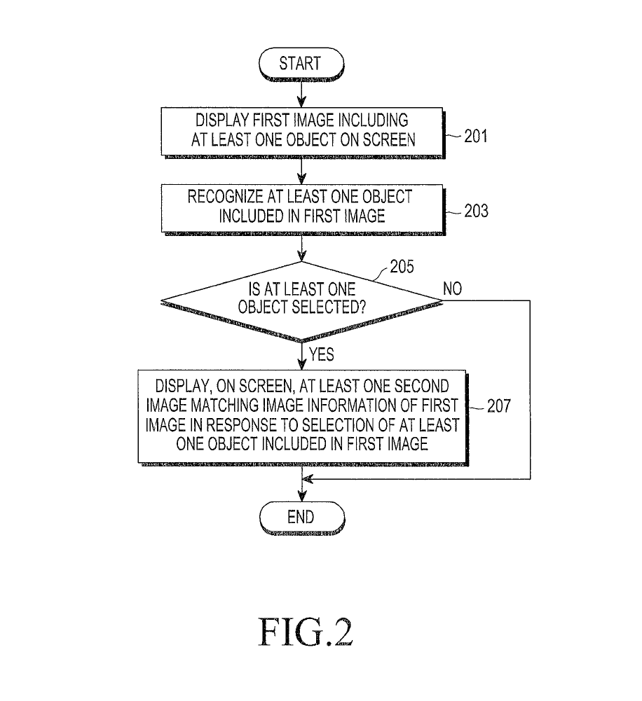

FIG. 2 is a flowchart illustrating a process of displaying an image according to an embodiment of the present disclosure.

Referring to FIG. 2, an electronic device displays, on a screen, a first image including at least one object in operation 201. The electronic device can display at least one image on the screen. The first image can be a picture, a video, or the like. Also, each image can include at least one of a picture and a video. For example, when the first image is a picture, an object can be, for example, an object or a person included in a picture recognizable by an electronic device.

The electronic device recognizes at least one object included in the first image in operation 203. The electronic device can recognize the at least one object included in the first image using an object recognition algorithm (for example, a facial recognition algorithm). The first image can be a picture directly photographed by a user of an electronic device 300, or can be an image captured or downloaded by the user of the electronic device 300. As another example, the first image can be a still image of a predetermined scene of a video being played back in the electronic device 300. For example, when the first image is a picture, the picture can include a man A, a woman B, and an object. In this instance, the electronic device can recognize at least one of the man A, the woman B, and the object, which are objects included in the picture, and can display the recognized object on a screen. The displayed object can correspond to an input of the user, and the controller 110 can emphasize (for example, highlight) a portion of the objects for display. That is, the portion can be an area displaying an entire object, or the portion can be a face when the object is a person.

The electronic device determines whether the at least one object included in the first image is selected in operation 205. Whether selection is made can be determined through at least one touch on an object by a body part of a user (for example, a finger including a thumb) or a touchable input unit (for example, a stylus pen or an electronic pen), and an object selected through the stylus pen or the electronic pen can be determined. Accordingly, the electronic device can receive an input of at least one gesture through at least one of a touch and a hovering, so as to select an object. The gesture includes at least one of a touch, a tap, a double tap, a flick, a drag, a drag-and-drop, a swipe, a multi-swipe, pinches, a touch-and-hold, a shake and a rotating.

The electronic device displays, on the screen, at least one second image matching image information of the first image, in response to the selection of the at least one object included in the first image, in operation 207. When the at least one object included in the first image is selected, the electronic device can read, from the storage unit, a second image having identical or similar information to the image information of the first image.

For example, the selection of the at least one object included in the first image can be a gesture provided to an object, in one of the upward direction, the downward direction, the left direction, and the right direction. Accordingly, the electronic device can display at least one second image matching the image information of the first image, on the screen. For example, the image information of the first image includes at least one of object identification information for identifying an object included in the first image, time information associated with the first image, and location information associated with the first image.

The object identification information can include, for example, a name of an object or a character string for enabling a user to identify an object. For example, a name of the man A included in the picture, a name of the woman B, or the like can be included.

The time information of the image can include information associated with a time when the image is photographed or stored. For example, the time information of an image can indicate a time when an image is photographed, downloaded, or modified. Also, the time information of an image can indicate a predetermined time range during which an image is photographed, downloaded, or modified. The predetermined time range can be, for example, 24 hours set by a user, or the electronic device can automatically set a time range. Therefore, an image photographed at 1 p.m. on Feb. 14, 2014 and an image photographed at 3 p.m. on Feb. 14, 2014 are regarded to have identical time information.

The location information of the image can indicate a location where an image is photographed or downloaded. Also, the time information of an image can indicate a predetermined location range where an image is photographed, downloaded, or modified. The predetermined location range can be set by a user, for example, a location within a 100-meter radius, or an electronic device can automatically set a location range. For example, when the location range set by the user is 100 m, the electronic device can regard images photographed in a location within a 100-meter radius from a location of photographing a reference image as images having identical location information. The range can be determined based on Global Positioning System (GPS) information received by the electronic device.

Accordingly, to determine the at least one second image matching the image information of the first image, the electronic device determines, for example, a second image corresponding to the object identification information of the first image, or a second image corresponding to the time information of the first image. As another example, a second image corresponding to the location information of the first image can be determined. After the determination, the electronic device can display at least one of the second images, on the screen. The electronic device's displaying of a second image corresponds to displaying, on a screen, a thumbnail corresponding to the image information or displaying, on a screen, a thumbnail corresponding to the image information, and the first image. Also, the electronic device displays one of the thumbnails corresponding to the image information.

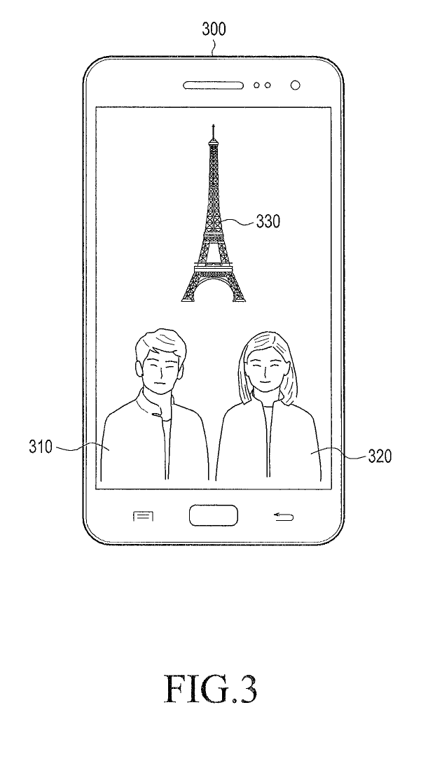

FIG. 3 illustrates a first image according to an embodiment of the present disclosure.

Referring to FIG. 3, a screen of the electronic device 300 displays a first image. The first image can include at least one object, and an object can be a man A 310, a woman B 320, or the Eiffel tower 330, or can be at least one of the man 310, the woman B 320, and the Eiffel tower 330. The first image can be a picture directly photographed by a user of the electronic device 300, or can be a picture captured or downloaded by the user of the electronic device 300. As another example, the first image can be a still image of a predetermined scene of a video being played back in the electronic device 300. Also, the electronic device 300 can store image information of the photographed first image. The image information of the image can include, for example, time information associated with a time when the first image is photographed, and location information associated with the image. The information associated with the image can be directly input by a user and the input information can be stored. Also, when the first image is a captured or downloaded picture, the image information can include time information associated with a time when the first image is captured or downloaded, or location information associated with a location where the image is captured or downloaded. The location information associated with a location where the image is captured or downloaded can include, for example, a web address or the like.

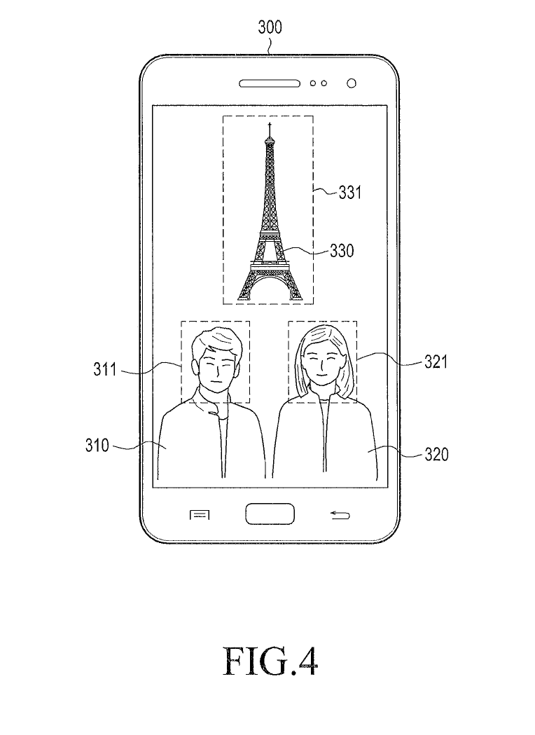

FIG. 4 illustrates recognition of objects included in a first image according to an embodiment of the present disclosure.

Referring to FIG. 4, the electronic device 300 can recognize at least one object included in a first image. The object can be, for example, a man A 310, a woman B 320, and the Eiffel tower 330. The electronic device 300 executes recognition (for example, facial recognition) on a partial area 311, and as a result, identifies the man A 310. Accordingly, the electronic device 300 determines whether the information of the man A matches any other image stored in the electronic device 300, and when matched image exists, associates the information of the man A with the matched image for storage. When the matched image does not exist, the electronic device 300 requests an image(s) corresponding to the man A from a server, receives the matched image(s) from the server, and stores the received image(s). Also, the electronic device 300 executes recognition (for example, facial recognition) on a partial area 321 to identify the woman B 320. The electronic device 300 determines whether the determined information associated with the woman B 320 matches any image stored in the electronic device 300, and when matched image exists, associates the information associated with the woman B 320 to an object 320 for storage. When the matched information does not exist, the electronic device 300 requests information corresponding to the woman B 320 from the server, receives the information from the server, and stores the received information.

Also, even when the object is an object other than a person, such as, the Eiffel tower 330, the electronic device 300 executes recognition with respect to a partial area 331 of the Eiffel tower 330 and determines information that identifies the Eiffel tower 330, so as to identify the Eiffel tower 330. Accordingly, the electronic device 300 determines whether the information associated with the Eiffel tower 330 matches the information stored in the electronic device 300, and when matched information exists, matches the information associated with the Eiffel tower 330 or the like to an object for storage. When the matched image does not exist, the electronic device 300 requests image corresponding to the Eiffel tower 330 from the server, receives the image(s) from the server, and stores the received information. The received information includes at least one of weather information associated with a location where the Eiffel tower 330 is located, location information, and temperature information.

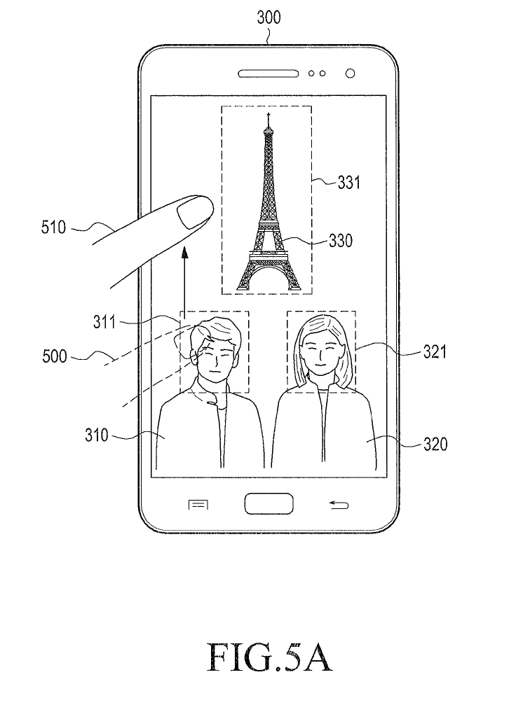

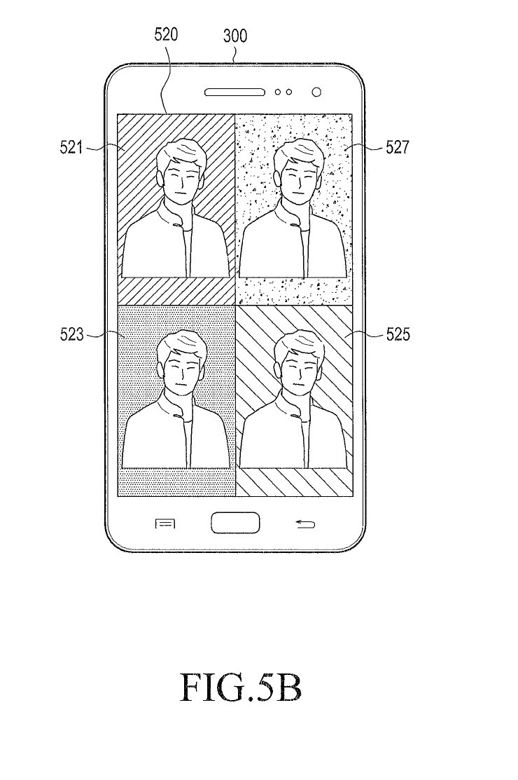

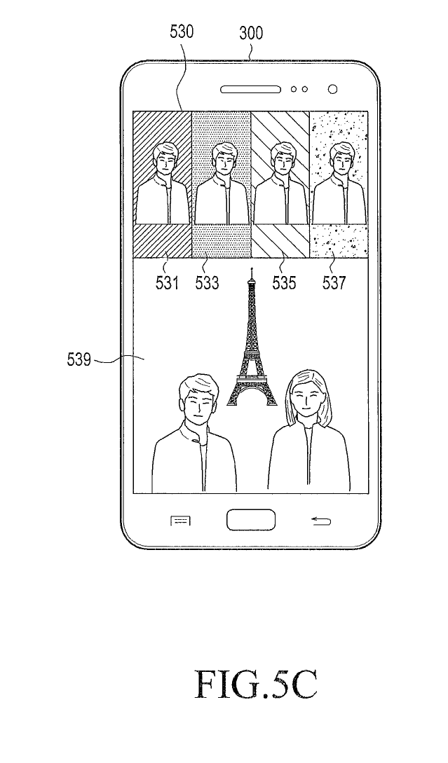

Hereinafter, an example will be provided, in which an electronic device controls the display in response to a gesture of a user when the user selects objects included in a first image and a gesture is applied to the selected objects, with reference to FIGS. 5 through 12.

According to various embodiments of the present disclosure, dragging or hovering can be executed with respect to a partial area of an object included in an image, and the direction of the drag or the hovering can be one of the upward direction, the downward direction, the left direction, and the right direction on a screen. The electronic device can display a second image including at least one of object identification information for identifying an object, time information associated with a time when an image is stored, and location information associated with an image, in response to the selected direction.

When an input (for example, dragging or hovering in the upward direction) is sensed on a partial area of an object included in the first image, the electronic device 300 can display an image that matches object identification information for identifying the object. Also, when an input (for example, dragging or hovering in the right direction) is sensed on a partial area of an object included in the first image, the electronic device 300 can display an image that matches time information associated with a time when the image was created. Also, when an input (for example, dragging or hovering in the left direction) is sensed on a partial area of an object included in the first image, the electronic device 300 can display an image that matches location information associated with the image. A result from each input can be set in advance or can vary by the user.

FIG. 5 is a diagram illustrating a process of displaying an image according to a first embodiment of the present disclosure.

For ease of description, in an image1 521 including a man A, an image2 523 including a man A, an image3 525 including a man A, and an image4 527 including a man A in FIGS. 5B through 5C, the man A can be an identical person. Each image (for example, the image 1 through the image 4) includes an identical person, but can include different backgrounds. The images can be different types of images, and can include different types of objects. Also, the images can include different time information and location information.

FIG. 5A illustrates selection of an object included in a first image and a gesture associated with the selection according to the first embodiment of the present disclosure.

Referring to FIG. 5A, the electronic device 300 displays the first image. The first image can include, for example, the man A 310, the woman B 320, and the Eiffel tower 330. Also, the first image displays the boundary of partial area 311 for recognition of the man A 310, and the boundary of partial area 321 for recognition of the woman B 320, and the boundary of partial area 331 for recognition of the Eiffel tower 330.

For example, the electronic device 300 can detect that the partial area 311 containing the man A 310 is selected and dragged 500 in the upward direction 510. Also, the electronic device 300 can detect that the partial area 311 containing the man A 310 is selected by a touch and moved by various gestures such as hovering or dragging. Subsequently, the electronic device 300 can display at least one second image provided in one of the screens of FIGS. 5B and 5C.

Also, as an example, the electronic device 300 can sense that the partial area 331 containing the Eiffel tower 330 on the screen is dragged in the upward direction, and the electronic device 300 can sense that the partial area 331 of the Eiffel tower 330 is selected and moved by various gestures such as hovering, in addition to dragging a touch. Subsequently, the electronic device 300 can display at least one second image including the Eiffel tower 330.

Also, as another example, the electronic device 300 can sense that the partial area 331 of the Eiffel tower 330 on the screen is dragged in the upward direction. Also, the electronic device 300 can sense that the partial area 331 of the Eiffel tower 330 is selected and moved by various gestures such as hovering, in addition to dragging a touch, and can determine that information matching the Eiffel tower does not exist in the electronic device. In this case, the electronic device can receive information associated with the Eiffel tower through a server. The information can include, for example, at least one of an image of an object, a location of an object, weather information associated with a location of an object, and temperature information.

Also, as another example, when an area that does not include object identification information is selected from the first image, the electronic device can display, on the screen, a popup window for receiving the object identification information, can receive an input of the object identification information from the user, and can store the input information.

FIG. 5B illustrates a second image that displays a thumbnail corresponding to the information associated with the object according to the first embodiment of the present disclosure.

Referring to FIG. 5B, the electronic device 300 can display a second image 520. The second image 520 can include at least one thumbnail. The thumbnail can include, for example, the image 1 521 including a man A, the image 2 523 including the man A, the image 3 525 including the man A, and the image 4 527 including the man A. The images including the man A can be images photographed in different times and different locations. Although the above described embodiment exemplifies four different pictures including the man A, the electronic device can display only the image 1 521 including the man A in another embodiment. Accordingly, the electronic device 300 senses dragging and hovering provided in the right/left directions in the image 1 including the man A, and sequentially displays the image 2 including the man A, the image 3 including the man A, and the image 4 including the man A. That is, at least one second image that matches the information associated with the object selected from the first image can be displayed.

FIG. 5C illustrates a second image that divides a thumbnail corresponding to the information associated with the object and the first image according to the first embodiment of the present disclosure.

Referring to FIG. 5C, the electronic device 300 can display the second image. The second image can include at least one thumbnail. The second image can include a first area 530 that displays at least one different image including the man A, and a second area 539 that displays the first image. The first area 530 can include, for example, an image 1 531 including the man A, an image 2 533 including the man A, an image 3 525 including the man A, and an image 4 537 including the man A. The images including the man A can be images photographed in different times and different locations. Although the above described embodiment exemplifies four different pictures including the man A, the electronic device 300 can display at least one picture including the man A in another embodiment. The second area 539 can display the first image. The size of the first area and the second area can be adjusted variably. Also, the size of the at least one of the thumbnails 531, 533, 535, and 537 or the size of the second area 539 can be adjusted variably.

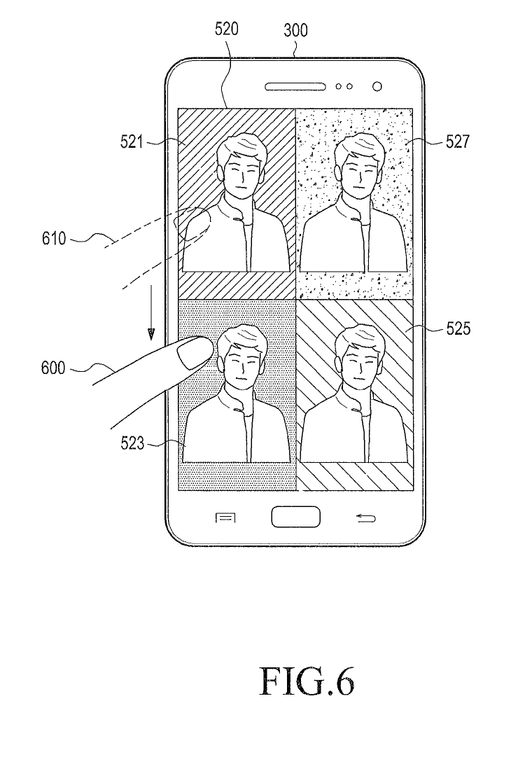

FIG. 6 illustrates a gesture for displaying the first image in the second image according to the first embodiment of the present disclosure.

The electronic device 300 can display the second image of FIG. 5B, in response to a gesture input into the first image of FIG. 5A.

Referring to FIG. 6, the electronic device 300 can display the second image 520. The second image 520 can include at least one of the thumbnails 521, 523, 525, and 527 including the man A. The thumbnail 520 can include, for example, the image 1 521 including the man A, the image 2 523 including the man A, the image 3 525 including the man A, and the image 4 527 including the man A. The images including the man A can be images photographed in different times and different locations. Although the above described embodiment exemplifies four different pictures including the man A, the electronic device can display the image 1 521 including the man A in another embodiment. Accordingly, the electronic device 300 can sense that a partial area of the second image is dragged 610 in the downward direction 600. The downward direction can be the direction opposite to the direction that is sensed by the electronic device to display the second image in the first area. Also, the electronic device 300 can sense that a partial area of the second image is selected and moved by various gestures such as hovering or the like, in addition to dragging a touch. Subsequently, the electronic device 300 can display again the first image of FIG. 5A.

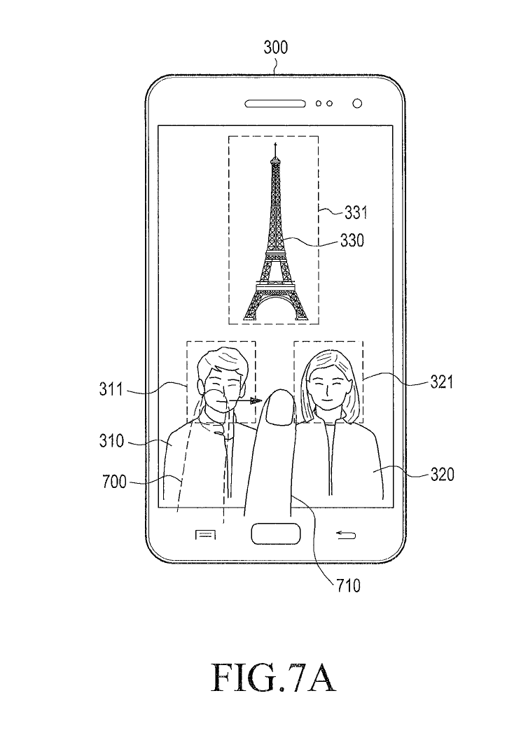

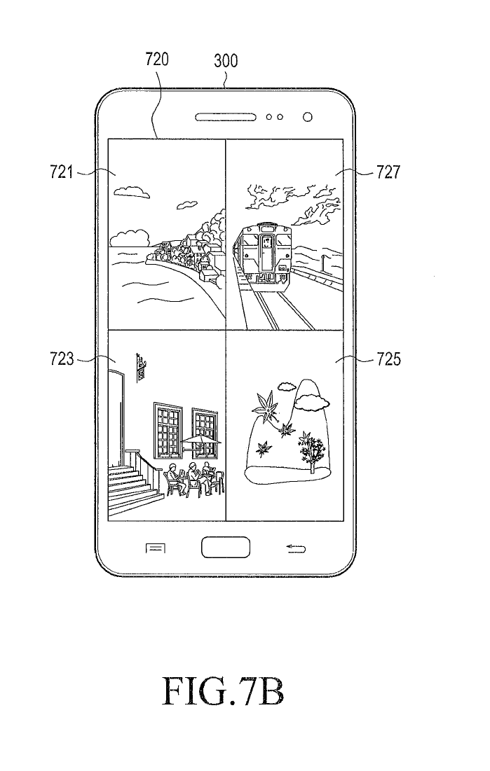

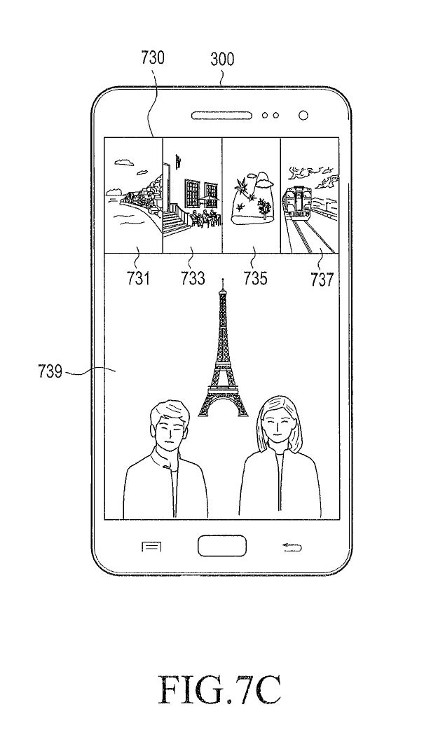

FIG. 7 is a diagram illustrating a process of displaying an image according to a second embodiment of the present disclosure.

For ease of description, an image 1 721 that matches time information of a first image, an image 2 723 that matches time information of the first image, an image 3 725 that matches time information of the first image, and an image 4 727 that matches time information of the first image in FIGS. 7B through 7C can have identical time information.

FIG. 7A illustrates selection of an object included in the first image and a gesture associated with the selection according to the second embodiment of the present disclosure.

Referring to FIG. 7A, the electronic device 300 displays the first image. The first image can include, for example, the man A 310, the woman B 320, and the Eiffel tower 330. Also, the first image displays the boundary of partial area 311 for recognition of the man A 310, and the boundary of partial area 321 for recognition of the woman B 320, and the boundary of partial area 331 for recognition of the Eiffel tower 330.

For example, the electronic device 300 can sense that the partial area 311 of the man A 310 on the screen is dragged 700 in the right direction 710, and the electronic device 300 can sense that the partial area 311 of the man A 310 is selected and moved by various gestures such as hovering and the like, in addition to dragging a touch. Subsequently, the electronic device 300 can display at least one second image provided in one of the screens of FIGS. 7B and 7C.

Also, as an example, the electronic device 300 can sense that the partial area 331 of the Eiffel tower 330 on the screen is dragged in the right direction, and the electronic device 300 can sense that the partial area 331 of the Eiffel tower 330 is selected and moved by various gestures such as hovering and the like, in addition to dragging a touch. Subsequently, the electronic device 300 can display at least one second image that matches the time information of the first image.

Also, as another example, the electronic device 300 can sense that the partial area 331 of the Eiffel tower 330 on the screen is selected and dragged in the right direction. Also, the electronic device 300 can sense that the partial area 331 of the Eiffel tower 330 is selected and moved by various gestures such as hovering and the like, in addition to dragging a touch, and can determine that information matching the time information of the second image does not exist in the electronic device. Accordingly, the electronic device can display, on the screen, a popup window for receiving an input of the time information of the second image, can receive an input of the time information from the user, and can store the input information.

FIG. 7B illustrates the second image with matching time information according to the second embodiment of the present disclosure.

Referring to FIG. 7B, the electronic device 300 can display a second image 720. The second image 720 can include at least one thumbnail that matches the time information of the first image. The thumbnail can include, for example, an image 1 721 that matches the time information of the first image, an image 2 723 that matches the time information of the first image, an image 3 725 that matches the time information of the first image, and an image 4 727 that matches the time information of the first image. The images that match the time information of the first image can be images obtained by photographing different objects or photographed in different locations. However, second images that match the time information of the first image can be images photographed within a predetermined time range. Also, although the above described embodiment exemplifies four different pictures that match the time information of the first image, the electronic device can display only the image 1 721 that matches the time information of the first image in another embodiment. Accordingly, the electronic device 300 senses dragging and hovering provided in the left and right directions in the image 1 721 that matches the time information, and sequentially displays the image 2 723 that matches the time information of the first image, the image 3 735 that matches the time information of the first image, and the image 4 727 that matches the time information of the first image. That is, the second image can display at least one second image that matches the time information of the first image.

FIG. 7C illustrates another second image corresponding to the time information according to the second embodiment of the present disclosure.

Referring to FIG. 7C, the electronic device 300 can display a second image. The second image can include at least one thumbnail. The second image can include a first area 730 that displays at least one different image that matches the time information of the first image, and a second image 739 that displays the first image. The first area 730 can include, for example, an image 1 731 that matches the time information of the first image, an image 2 733 that matches the time information of the first image, an image 3 735 that matches the time information of the first image, and an image 4 737 that matches the time information of the first image. The images that match the time information of the first image can include different objects from each other or can be photographed in different locations. The above described example exemplifies four different images that match the time information of the first image. Also, the size of the first area and the second area can be adjusted variously. Also, the size of the at least one of the thumbnails 731, 733, 735, and 737 or the size of the second area can be adjusted variably.

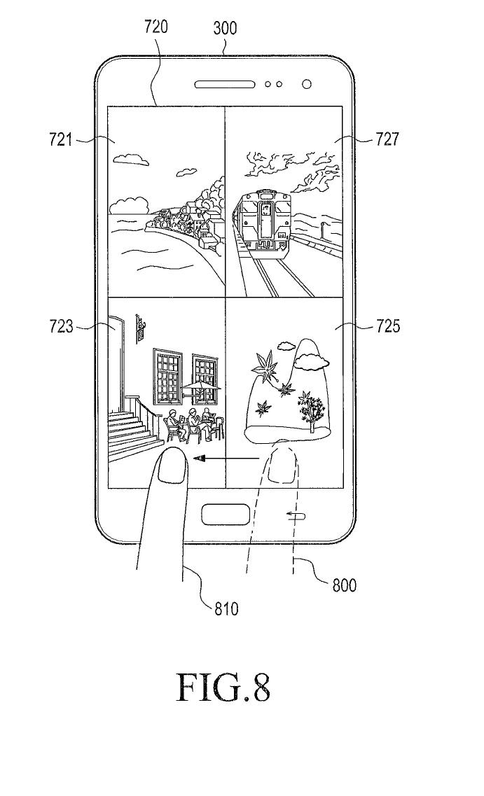

FIG. 8 illustrates a gesture for displaying the first image in the second image according to the second embodiment of the present disclosure.

Referring to FIG. 8, the electronic device 300 can display the second image 720. The second image 720 can include at least one thumbnail 721, 723, 725, and 727 that matches the time information of the first image. The images that match the time information of the first image can include different objects from each other or can be photographed in different locations. Although the above described embodiment exemplifies four different pictures that match the time information of the first image, the electronic device can display the image 1 721 that matches the time information of the first image. Accordingly, the electronic device 300 can sense that a partial area of the second image is dragged 800 in the left direction 810. The left direction can be the direction opposite to the direction that is sensed by the electronic device to display the second image in the first image. Also, the electronic device 300 can sense that a partial area of the second image is selected and moved by various gestures such as hovering or the like, in addition to dragging a touch. Subsequently, the electronic device 300 can display again the first image of FIG. 7A.

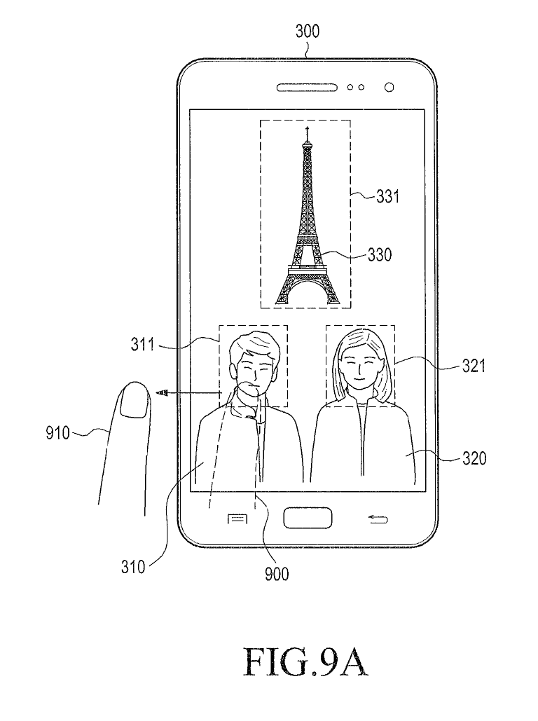

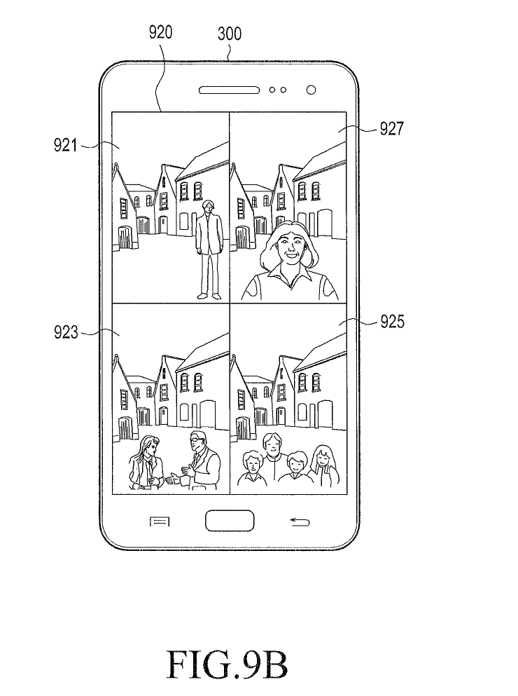

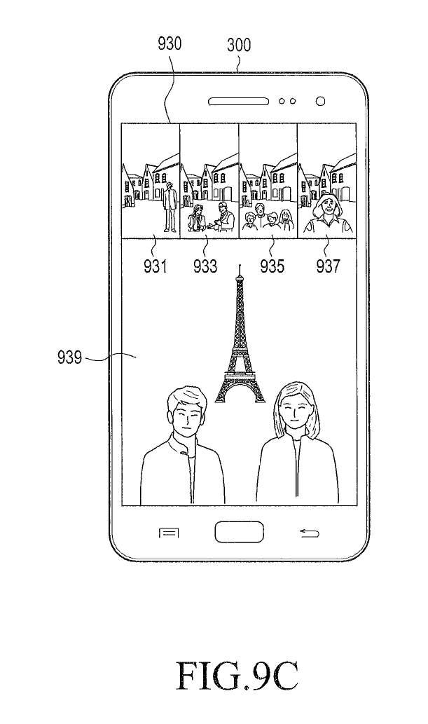

FIG. 9 is a diagram illustrating a process of displaying an image according to a third embodiment of the present disclosure.

For ease of description, an image 1 921 that matches location information of a first image, an image 2 923 that matches the location information of the first image, an image 3 925 that matches the location information of the first image, and an image 4 927 that matches the location information of the first image in FIGS. 9B through 9C are provided as images having different types of objects in an identical background. However, the images can have identical time information, and can include an identical type of object.

FIG. 9A illustrates selection of an object included in the first image and a gesture associated with the selection according to the third embodiment of the present disclosure.

Referring to FIG. 9A, the electronic device 300 displays the first image. The first image can include, for example, the man A 310, the woman B 320, and the Eiffel tower 330, and can display the boundary of partial area 311 for recognition of the man A 310, the boundary of partial area 321 for recognition of the woman B 320, and the boundary of partial area 331 for recognition of the Eiffel tower 330.

For example, the electronic device 300 can sense that the partial area 311 of the man A 310 on the screen is selected 900 and dragged in the left direction 910, and the electronic device 300 can sense that the partial area 311 of the man A 310 is selected and moved by various gestures such as hovering and the like, in addition to dragging a touch. Subsequently, the electronic device 300 can display at least one second image provided in one of the screens of FIGS. 9B and 9C.

Also, as an example, the electronic device 300 can sense that the partial area 331 of the Eiffel tower 330 on the screen is dragged in the left direction, and the electronic device 300 can sense that the partial area 331 of the Eiffel tower 330 is selected and moved by various gestures such as hovering, in addition to dragging a touch. Subsequently, the electronic device 300 can display at least one second image that matches the location information of the first image.

Also, as another example, the electronic device 300 can sense that the partial area 331 of the Eiffel tower 330 on the screen is selected and dragged in the left direction. Also, the electronic device 300 can sense that the partial area 331 of the Eiffel tower 330 is selected and moved by various gestures such as hovering and the like, in addition to dragging a touch, and can determine that information matching the location information of the second image does not exist in the electronic device. Accordingly, the electronic device can display, on the screen, a popup window for receiving an input of the location information of the second image, can receive an input of the location information from the user, and can store the input information.

FIG. 9B illustrates a second image corresponding to location information according to the third embodiment of the present disclosure.

Referring to FIG. 9B, the electronic device 300 can display a second image 920. The second image 920 can include at least one thumbnail that matches the location information of the first image. The thumbnail 920 can include, for example, the image 1 921 that matches the location information of the first image, the image 2 923 that matches the location information of the first image, the image 3 925 that matches the location information of the first image, and the image 4 927 that matches the location information of the first image. The images that match the location information of the first image can be images obtained by photographing different objects or photographed in different locations. However, second images that match the location information of the first image can be images photographed within a predetermined location range. Also, although the above described embodiment exemplifies four different pictures that match the location information of the first image, the electronic device can display the image that matches the location information of the first image. Accordingly, the electronic device 300 senses dragging and hovering provided in the left and right directions in the image 1 921 that matches the location information, and sequentially displays the image 2 923 that matches the location information of the first image, the image 3 935 that matches the location information of the first image, and the image 4 927 that matches the location information of the first image. That is, the second image can display at least one second image that matches the location information of the first image.

FIG. 9C illustrates another second image corresponding to the location information according to the third embodiment of the present disclosure.

Referring to FIG. 9C, the electronic device 300 can display a second image. The second image can include at least one thumbnail. The second image can include a first area 930 that displays at least one different image that matches the location information of the first image, and a second area 939 that displays the first image. The first area 930 can include, for example, an image 1 931 that matches the location information of the first image, an image 2 933 that matches the location information of the first image, an image 3 935 that matches the location information of the first image, and an image 4 937 that matches the location information of the first image. The images that match the location information of the first image can include different objects from each other or can be photographed in different times. The size of the first area and the second area can be adjusted variously. Also, the size of the at least one of the thumbnails 931, 933, 935, and 937 or the size of the second area 939 can be adjusted variably.

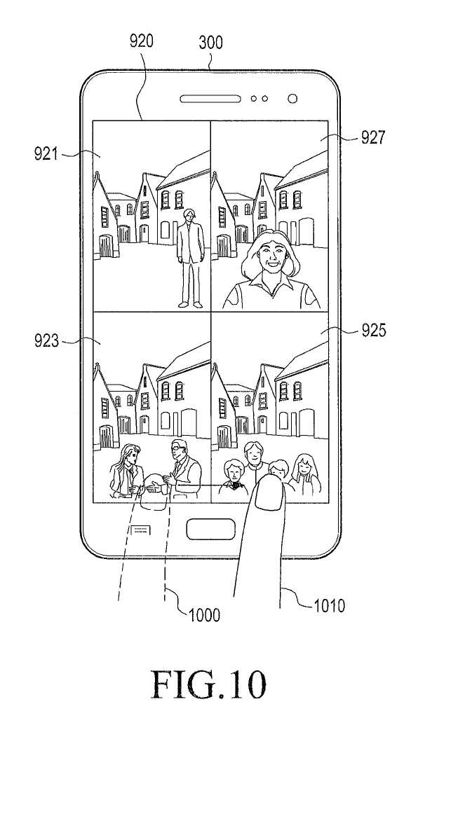

FIG. 10 illustrates a gesture for relocating the first image onto the second image according to the third embodiment of the present disclosure.

Referring to FIG. 10, the electronic device 300 can display the second image 920. The second image 920 can include the thumbnails 921, 923, 925, and 927 including at least one different image that matches the time information of the first image. The thumbnail 920 can include, for example, the image 1 921 that matches the location information of the first image, the image 2 923 that matches the location information of the first image, the image3 925 that matches the location information of the first image, and the image 4 927 that matches the location information of the first image. The images that match the location information of the first image can include different objects from each other or can be photographed in different times. Also, although the above described embodiment exemplifies four different pictures that match the location information of the first image, the electronic device can display only the image1 921 that matches the location information of the first image in another embodiment. Accordingly, the electronic device 300 can sense that a partial area of the second image is dragged 1000 in the right direction 1010. Then the object of the first image2 923 is copied (or cut) and pasted onto the image3 924.

The right direction can be the direction opposite to the direction that is sensed by the electronic device to display the second image in the first image. Also, the electronic device 300 can sense that a partial area of the second image is selected and moved by various gestures such as hovering or dragging a touch. Subsequently, the electronic device 300 can display again the first image of FIG. 9A.

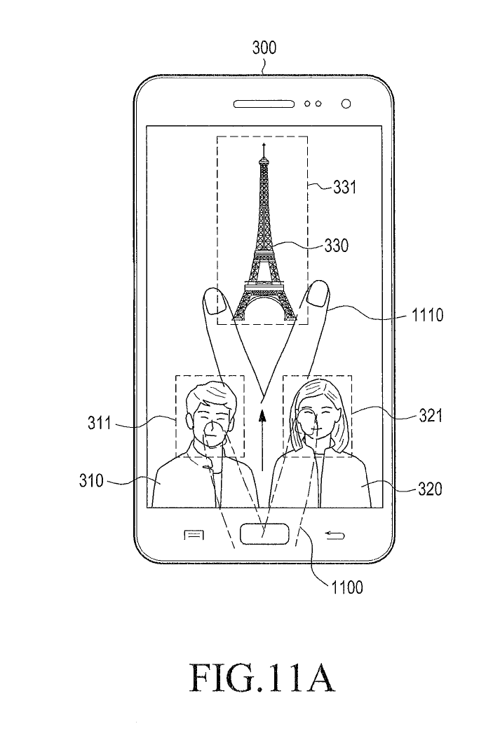

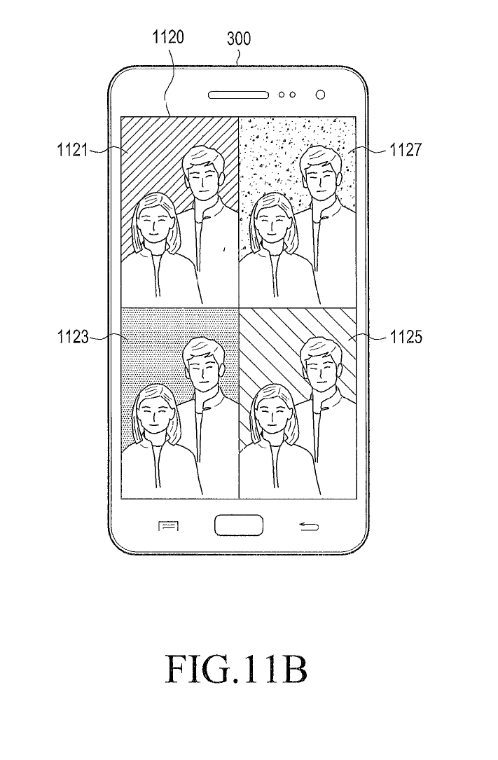

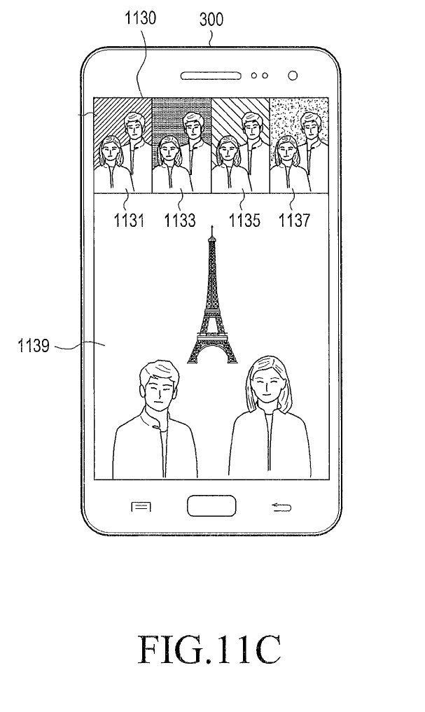

FIG. 11 is a diagram illustrating a process of displaying an image according to a fourth embodiment of the present disclosure.

For ease of description, an image 1 1121 including both the man A 310 and the woman B 320 of an first image, an image 2 1123 including both the man A 310 and the woman B 320 of the first image, an image 3 1125 including both the man A 310 and the woman B 320 of the first image, and an image 4 1127 including both the man A 310 and the woman B 320 of the first image, provided in FIGS. 11B and 11C, can include different time information and location information.

FIG. 11A illustrates selection of an object included in the first image and a gesture associated with the selection according to the fourth embodiment of the present disclosure.

Referring to FIG. 11A, the electronic device 300 displays the first image. The first image can include, for example, the man A 310, the woman B 320, and the Eiffel tower 330. Also, the first image displays the boundary of partial area 311 for recognition of the man A 310, and the boundary of partial area 321 for recognition of the woman B 320, and the boundary of partial area 331 for recognition of the Eiffel tower 330.

For example, the electronic device 300 can sense that the partial area 311 of the man A 310 and the partial area 321 of the woman B 320 on the screen are selected 1100 and dragged in the upward direction 1110, and the electronic device 300 can sense that the partial area 311 of the man A 310 and the partial area 321 of the woman B 320 are selected and moved by various gestures such as hovering and the like, in addition to dragging a touch. Subsequently, the electronic device 300 can display at least one second image provided in one of the screens of FIGS. 11B and 11C.

For example, the electronic device 300 can sense that the partial area 331 of the Eiffel tower 330 and the partial area 321 of the woman B 320 on the screen are selected and dragged in the upward direction, and the electronic device 300 can sense that the partial area 331 of the Eiffel tower 330 and the partial area 321 of the woman B 320 are selected and moved by various gestures such as hovering and the like, in addition to dragging a touch. Subsequently, the electronic device 300 can display at least one second image including both the Eiffel tower 330 and the woman B 320.

Also, as another example, the electronic device 300 can sense that the partial area 331 of the Eiffel tower 330 and the partial area 321 of the woman B 320 are selected and dragged in the left direction, and the electronic device 300 can sense that the partial area 331 of the Eiffel tower 330 and the partial area 321 of the woman B 320 are selected and moved by various gestures such as hovering and the like, in addition to dragging a touch, and can determine that information including both the Eiffel tower 330 and the woman B 320 does not exist in the electronic device. Accordingly, the electronic device can display, on the screen, a popup window for receiving an input of identification information for identifying the Eiffel tower 330 and the woman B 320 of the second image, and can receive and store the location information from the user.

FIG. 11B illustrates a second image corresponding to biographic information of a plurality of persons from among information associated with an object according to the fourth embodiment of the present disclosure.

Referring to FIG. 9B, the electronic device 300 can display a second image 1120. The second image 1120 can include at least one thumbnail including both the man A 310 and the woman B 320 of the first image. The thumbnail 1120 can include, for example, an image 1 1121 including both the man A 310 and the woman B 320, an image 2 1123 including both the man A 310 and the woman B 320, an image 3 1125 including both the man A 310 and the woman B 320, and an image 4 1127 including both the man A 310 and the woman B 320. The images including both the man A 310 and the woman B 320 of the first image can include different objects from each other, and can be photographed in different times and places. However, the second image can include both the man A 310 and the woman B 320 of the first image. Also, although the above described embodiment exemplifies four different pictures that match the location information of the first image, the electronic device can display only the image 1 1121 including both the man A 310 and the woman 320 of the first image in another embodiment. Accordingly, the electronic device 300 can sense dragging and hovering provided in the right and left directions in the image 1 1121, and sequentially displays the image 2 1123 including both the man A 310 and the woman B 320, the image 3 1125 including both the man A 310 and the woman B 320, and the image 4 1127 including both the man A 310 and the woman B 320. That is, the second image can display at least one second image that includes all the objects selected from the first image. FIG. 11C illustrates another second image corresponding to biographic information of a plurality of persons from among information associated with an object according to the fourth embodiment of the present disclosure.

Referring to FIG. 11C, the electronic device 300 can display the second image 520. The second image 520 can divide a thumbnail 1130 including at least one different image that includes both the man A 310 and the woman B 320, and a first image 1139, for display. The thumbnail 1130 can include, for example, an image 1 1131 including both the man A 310 and the woman B 320, an image 2 1133 including both the man A 310 and the woman B 320, an image 3 1135 including both the man A 310 and the woman B 320, and an image 4 1137 including both the man A 310 and the woman B 320. The images including both the man A 310 and the woman B 320 can include different objects from each other, and can be photographed in different times and places. The above described embodiment exemplifies four different pictures including the man A. Also, as another example, the location and size of the division for the thumbnail 1130 and the first image 1139 can be changed based on settings of a user.

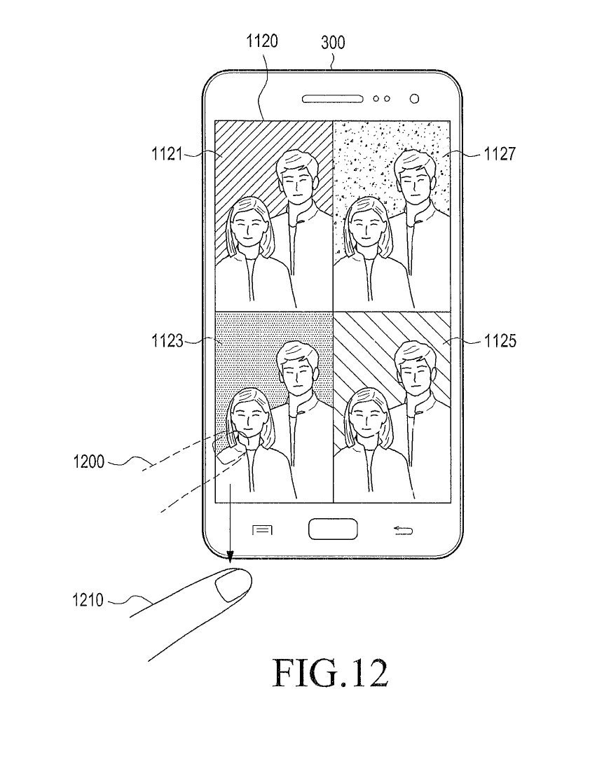

FIG. 12 illustrates a gesture for displaying the first image in the second image according to the fourth embodiment of the present disclosure.

Referring to FIG. 12, the electronic device 300 can display the second image 1120. The second image 1120 can include a thumbnail 1121 including at least one different image that includes both the man A 310 and the woman B 320 of the first image. The thumbnail 1121 can include, for example, the image 1 1121 including both the man A 310 and the woman B 320, the image 2 1123 including both the man A 310 and the woman B 320, the image 3 1125 including both the man A 310 and the woman B 320, and the image 4 1127 including both the man A 310 and the woman B 320. The images including both the man A 310 and the woman B 320 can further include a different object, and can be photographed in different times and places. Although the above described embodiment exemplifies four different pictures including both the man A 310 and the woman B 320, the electronic device can display at least one image (for example, the image 1 1121) including both the man A 310 and the woman B 320 of the first image. Accordingly, the electronic device 300 can sense that a partial area of the second image is dragged 800 in the downward direction 810. The downward direction can be the direction opposite to the direction that is sensed by the electronic device to display the second image in the first image. Also, the electronic device 300 can sense that a partial area of the second image is selected and moved by various gestures such as hovering or the like, in addition to dragging a touch. Subsequently, the electronic device 300 can display again the first image of FIG. 11A.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for an electronic device to display an image, the method comprising:
displaying a first image including one or more objects on a screen; and
receiving an input to select at least one of the one or more objects;
searching for at least one second image that matches the selected at least one, using image information of the first image; and
displaying at least one second image on the screen.

2. The method of claim 1, wherein the image information includes at least one of object identification information for identifying the object, time information indicating when the first image was created, and location information associated with the first image.

3. The method of claim 1, wherein, when an area that does not include object identification information is selected from the first image, the method further comprises:
displaying a popup window for receiving the object identification information on the screen; and
receiving and storing the object identification information.

4. The method of claim 1, further comprising:
dividing the screen into a first portion for displaying a thumbnail presenting the image information, a second portion for a thumbnail presenting the image information and the first image for the display, and a third portion for displaying one of thumbnails presenting the image information.

5. The method of claim 1, wherein the object is selected by a gesture provided in one of a upward direction, a downward direction, a left direction, and a right direction.

6. The method of claim 1, wherein, when a gesture is input in a direction opposite to a gesture input for selecting the at least one object in a state in which the second image is displayed, the method further comprises:
displaying the first image.

7. The method of claim 1, wherein an object included in at least one second image includes at least one selected object included in the first image.

8. The method of claim 1, wherein time information of the at least one second image is included in time information of the first image and a predetermined time range.

9. The method of claim 1, wherein location information of the at least one second image is included in location information of the first image and a predetermined location range.

10. A method for matching images in an electronic device to, the method comprising:
displaying a first image including one and more objects on a screen;
receiving a gesture for selecting an object in the first image, in one of a upward direction, a downward direction, a left direction, and a right direction;
obtaining image information of the first image;
when a first image matching the selected object of the first image does not exist in the electronic device, requesting a second image matching the selected object and the image information of the first image from a server;
receiving the second image from the server; and
displaying a second image on the screen.

11. The method of claim 10, wherein the image information includes at least one of object identification information for identifying the object, time information associated with a time when the first image was created, and location information associated with the first image.

12. The method of claim 11, wherein the image information of the first image includes at least one of an image of the object, a location of the object, weather information of the location of the object, and temperature information.

13. A method for matching images in an electronic device, the method comprising:
displaying a first image including at least one object on a screen;
detecting a gesture for selecting an object in the first image, in one of a upward direction, a downward direction, a left direction, and a right direction;
obtaining image information of the first image; and
displaying the image information of the first image on the screen.

14. The method of claim 13, wherein the image information of the first image includes at least one of object identification information for identifying the object, time information associated with a time when the first image is stored, and location information associated with the first image.

15. An electronic device for matching images, the electronic device comprising:
a screen configured to display a first image including one or more objects;
a sensor configured to detect an input to select at least one of the one or more objects;
a controller configured to:
search for at least one second image that matches the selected at least one, using image information of the first image; and
cause display at least one second image on the screen.

16. The electronic device of claim 15, wherein, when the image information includes at least one of object identification information for identifying the object, time information associated with a time when the first image is stored, and location information associated with the first image.

17. The electronic device of claim 15, wherein, when an area that does not include the object identification information is selected, the controller is configured to cause the screen to display a popup window for receiving the object identification information, receive the object identification information, and store the information in a storage unit.

18. The electronic device of claim 15, wherein the controller is configured to divide the screen into one of a first portion for displaying a thumbnail presenting the image information, a second portion for dividing the thumbnail presenting the image information and the first image for the display, and a third portion for displaying one of thumbnails presenting the image information.

19. The electronic device of claim 15, wherein the object is selected by a gesture provided in one of a upward direction, a downward direction, a left direction, and a right direction.

20. The electronic device of claim 15, wherein, when a gesture is input in a direction opposite to a gesture input for selecting the at least one object, in a state in which the second image is displayed, the controller performs a control to display the first image on the screen.

21. The electronic device of claim 15, wherein an object in the second image matches the selected object included in the first image.

22. The electronic device of claim 15, wherein time information of the at least one second image falls into a predetermined time range of the first image.

23. The electronic device of claim 15, wherein location information of the second image falls into a predetermined location range of the first image.

24. An electronic device for displaying an image, comprising:
a screen configured to display a first image including one or more objects;
a controller configure to:
detect a gesture for selecting at least one object included in the first image, in one of a upward direction, a downward direction, a left direction, and a right direction,
search for an image matching the selected object in the electronic device, using image information of the first image, and
inquiring of an image matching the selected object, using image information of the first image to a server when the matching image does not exist in the electronic device; and
a communication unit configured to receive the information of the matching image from the server, wherein the screen is configured to display the matching image.

25. The electronic device of claim 24, wherein the image information includes at least one of object identification information for identifying the object, time information associated with a time when the first image is stored, and location information associated with the first image.

26. The electronic device of claim 25, wherein the image information of the first image includes at least one of an image of the object, a location of the object, weather information of the location of the object, and temperature information.

27. An electronic device for displaying an image, comprising:
a screen configured to display a first image including at least one object, the first image having image information; and
a controller configured to:
determine a gesture for selecting at least one object included in the first image, in one of a upward direction, a downward direction, a left direction, and a right direction, and
obtain image information of the first image.

28. The electronic device of claim 27, wherein the image information of the first image includes at least one of object identification information for identifying the object, time information associated with a time when the first image is stored, and location information associated with the first image.
